(19) United States
(12) Patent Application Publication
(10) Pub. No.: US 2007/0195105 A1
(43) Pub. Date: Aug. 23, 2007

(54) Dynamic wallpaper on mobile communication device

(76) Inventor: Anu Koberg, San Diego, CA (US)

Correspondence Address: QUALCOMM INCORPORATED, 5775 MOREHOUSE DR., SAN DIEGO, CA, 92121, US

(21) Appl. No.: 11/357,266

(22) Filed: Feb. 17, 2006

(51) Int. Cl. G09G 5/00

(52) U.S. Cl. 345/582

(57) ABSTRACT

A method, apparatus, set of executable instructions, and computer readable medium for enabling dynamic updating of a mobile communication device display is described. Wallpaper, including dynamic content, is displayed and automatically updated on the display. A computer system for dynamically updating a mobile communication device display is described. The computer system includes a network interface adapted to communicate with the mobile communication device and an update component for automatically determining whether wallpaper including dynamic content is to be transferred to the mobile communication device via the network interface.

### FIELD OF THE DESCRIBED EMBODIMENTS

The described embodiments relate to a method, apparatus, set of instructions for execution by a processor, and computer-readable medium for enabling dynamic wallpaper on a mobile communication device.

### BACKGROUND

It is known in the art to display content, i.e., text and images, on the background of a display on a mobile communication device (MCD), e.g., a cellular telephone, or other wireless handheld communication device. The displayed background content (hereafter referred to as wallpaper) is displayed as a background on the display of the MCD. Applications, windows, dialogs, and other interface elements may be displayed, to a greater or lesser extent, over top or in front of the wallpaper, but the wallpaper remains displayed at the lowest level. In some instances, a sequence of content, e.g., multiple images, may be displayed in an animation fashion to display a sense of action to a user of the device. Even though animation may be employed in some cases, the content displayed to the user is static. That is, once selected and caused to be displayed, the displayed content does not change.

In order to change or update the displayed content, the user must perform multiple interactions with the MCD. For example, the user must access and navigate a menu or other mechanism to change a setting specifying the wallpaper to be displayed, e.g., a user preference setting, by selecting an image stored in memory of the MCD, or an image in memory which was downloaded via a network connection, e.g., a cable or over the air transmission to the handset. After the user selection is made, the displayed content changes. Further changes to the displayed content require the same sequence of operations/interactions. Navigation of menus and selection of particular settings is often cumbersome and time-consuming for a user of an MCD.

Further, as described above, the wallpaper is static in nature and requires interaction with a user to be updated. Typically, a user chooses a single image for display, e.g., a favorite location, family member, significant other, favorite actor/actress, or family pet, and does not change the image.

### SUMMARY

The described embodiments provide a method, apparatus, set of instructions for execution by a processor, and computer-readable medium for enabling dynamic wallpaper on a mobile communication device.

A method embodiment includes displaying wallpaper on a display of a mobile communication device. The wallpaper includes dynamic content. The wallpaper on the display is automatically updated.

A computer system embodiment, e.g., a server-based system, includes a network interface adapted to communicate with a mobile communication device and an update component for automatically determining whether wallpaper including dynamic content is to be transferred to the mobile communication device via the network interface.

A mobile communication device embodiment includes a processor, a display coupled to the processor and displaying wallpaper responsive to the processor, and a memory coupled to the processor having instructions. When executed, the instructions cause the processor to display wallpaper on the display, and automatically update the wallpaper on the display, wherein the wallpaper includes dynamic content.

A system embodiment for automatically updating a wallpaper displayed on a mobile communication device display includes communication means for automatically receiving updated wallpaper for display on the mobile communication device and updating means for automatically updating wallpaper including dynamic content, if updated wallpaper is available for transfer to the mobile communication device.

Still other advantages of the various embodiments will become readily apparent to those skilled in the art from the following detailed description, wherein the embodiments are shown and described, simply by way of illustration of the best mode contemplated of carrying out the embodiments. As will be realized, the embodiments are capable of other and different forms, and their several details are capable of modifications in various obvious respects, all without departing from the scope of the described embodiments.

### DESCRIPTION OF THE DRAWINGS

The described embodiments are illustrated by way of example, and not by limitation, in the figures of the accompanying drawings, wherein elements having the same reference numeral designations represent like elements throughout and wherein:

FIG. 1 is a diagram of a system useable in conjunction with an embodiment;

FIG. 2 is a high level block diagram of a processing system useable in conjunction with an embodiment;

FIG. 3 is a process flow diagram of a first embodiment;

FIG. 4 is a process flow diagram of a second embodiment; and

FIG. 5 is a process flow diagram of an update component useable in conjunction with an embodiment.

### DETAILED DESCRIPTION

In contrast with the above-described approaches, the mechanism of an embodiment enables dynamic updating of a mobile communication device display. There are at least two embodiments for the mechanism of dynamically updating the mobile communication device display.

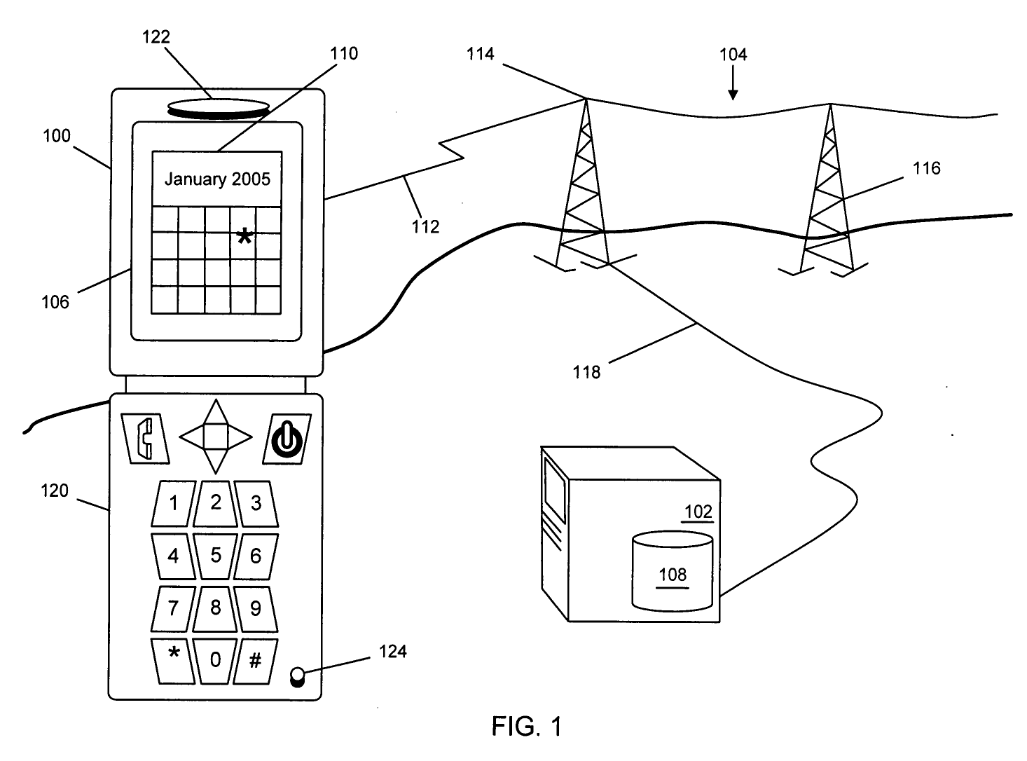

In a first embodiment described with reference to FIG. 1, a mobile communication device (MCD) 100 automatically connects with a computer system 102 via a communication network 104 in order to determine if updated content exists for presentation as wallpaper on a display 106 of MCD 100. MCD 100 connects based on a preset time basis, e.g., a periodic, a recurrent, and/or a single specified time. If updated content exists, e.g., in a data store 108 in computer system 102, MCD 100 retrieves the updated content via communication network 104 and updates the displayed wallpaper on display 106. For example, if MCD 100 displays a calendar 110 of user appointments as wallpaper on display 106, MCD 100 connects with computer system 102 and determines if a corresponding user calendar stored in data store 108 on the computer system differs from calendar 110 displayed on the MCD. If the calendars differ, MCD 100 retrieves the calendar from computer system 102 and displays the retrieved calendar as wallpaper on display 106.

In a second embodiment, also described with reference to FIG. 1, computer system 102 automatically connects with MCD 100 if updated content exists, e.g., in data store 108, on the computer system for display as wallpaper on display 106 of the MCD. Computer system 102 transmits the updated content to MCD 100 via communication network 104 and causes the MCD to present the updated content as wallpaper on display 106. Using the above calendar example, if the user calendar on the computer system is updated, computer system 102 connects with MCD 100 and transmits the calendar from the computer system to the MCD for display as wallpaper on display 106.

The term “wallpaper” as used herein is intended to include a displayed graphic having dynamic content and including images, text, video, and/or a combination thereof as the lowest level background displayed on MCD 100. The terms “dynamic content” as used herein is intended to include content which may change over a period of time. Examples of such content includes calendar items, task lists, weather information, traffic information, navigation information, sports information, news, financial information, entertainment information, etc. For example, entertainment information may include a daily horoscope, television, music, and movie information and navigation information may include a current position information about MCD 100, e.g., based on global positioning system information and/or other position determining mechanisms available to the MCD. Additionally, content may change depending on the location of MCD 100, e.g., as a user travels from one location to another, traffic information and/or navigation information displayed as wallpaper may be updated for the particular locale of the user at the time.

According to each of the above-described embodiments, the user need not initiate the update of the wallpaper on MCD 100, i.e., the displayed wallpaper is automatically updated. Users are able to view updated wallpaper without being required to navigate complicated menu structures and device functionality.

As depicted in FIG. 1, MCD 100 connects wirelessly via a wireless connection 112 to a wireless access point 114 within range of the MCD. Wireless access point 114 forms a part of communication network 104 including, for example, another wireless access point 116 and additional wired and wireless connections and devices. Computer system 102 connects to communication network 104 via a wired connection 118 and is able to transmit and receive communication signals with devices connected with communication network 104, e.g., MCD 100.

MCD 100 may be a wireless telephone, e.g., a cellular or personal communication service (PCS) telephone, and other similar wireless handheld communication devices, and includes display 106 for displaying information to a user and a user input device 120 for receiving user input including information and commands to the MCD, e.g., a numeric keypad, a set of navigation buttons, and additional buttons providing functionality as depicted in FIG. 1. MCD 100 further includes a speaker 122 for generating audio and a microphone 124 for capturing audio.

MCD 100 includes additional hardware and software for communicating with other mobile communication devices (not shown) or other networked devices, e.g., computer system 102, connected with communication network 104. MCD 100 includes a combination of hardware, software, and/or firmware for providing connectivity to communication network 104 to a user of the device.

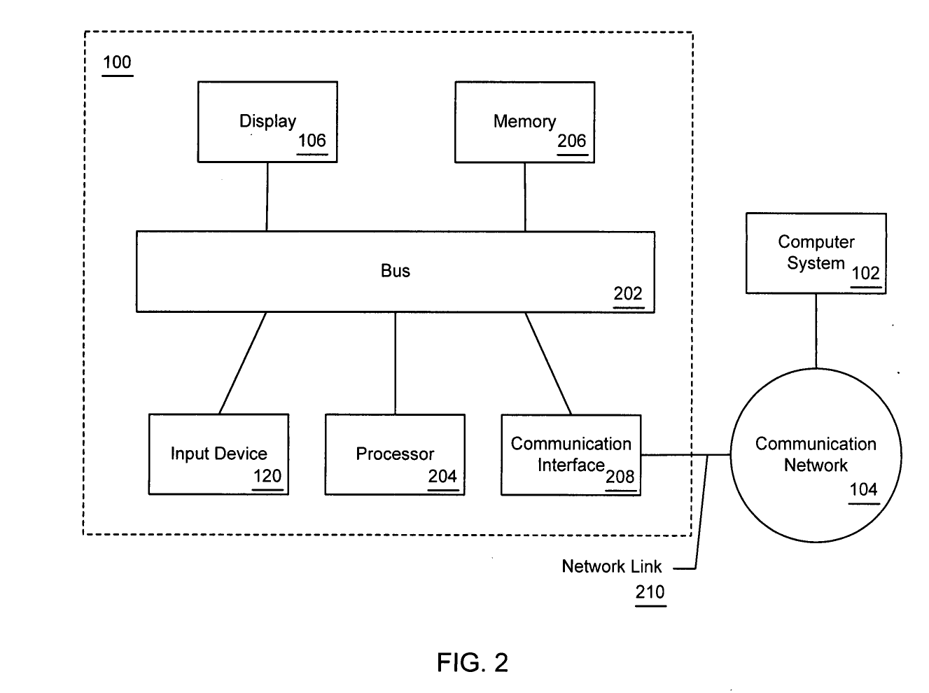

FIG. 2 is a block diagram illustrating an exemplary MCD 100 upon which an embodiment may be implemented. MCD 100 includes a bus 202 or other communication mechanism for communicating information, and a processor 204 coupled with bus 202 for processing information. MCD 100 also includes a memory 206, such as a random access memory (RAM) or other dynamic storage device, coupled to the bus 202 for storing instructions to be executed by processor 204. Memory 206 also may be used for storing wallpaper, e.g., images, text, etc., temporary variables or other intermediate information during execution of instructions to be executed by processor 204. In one embodiment, memory 206 stores previously-displayed wallpaper in addition to the currently displayed wallpaper.

MCD 100 is coupled via bus 202 to display 106, such as a liquid crystal display (LCD) or other display technology, for displaying information to the user. Input device 120, described above, is coupled to bus 202 for communicating information and command selections to the processor 204.

According to one embodiment, MCD 100 operates in response to processor 204 executing sequences of instructions contained in memory 206 and responsive to input received via input device 120, or communication interface 208. Such instructions may be read into memory 206 from a computer-readable medium or communication interface 208.

Execution of the sequences of instructions contained in memory 206 causes the processor 204 to perform the process steps described below. In alternative embodiments, hard-wired circuitry may be used in place of or in combination with computer software instructions to implement the embodiments. Thus, embodiments are not limited to any specific combination of hardware circuitry and software.

MCD 100 also includes a communication interface 208 coupled to the bus 202. Communication interface 208 provides two-way data communication. For example, communication interface 208 may be a wireless communication link according to a wireless communication protocol, e.g., GSM, CDMA, WCDMA, etc. In any such implementation, communication interface 208 sends and receives electrical, electromagnetic or optical signals which carry digital data streams representing various types of information. Of particular note, the communications through interface 208 may permit transmission or receipt of wallpaper for display on display 106.

Network link 210 typically provides data communication through one or more networks to other devices. For example, network link 210 may provide a connection through communication network 104 to computer system 102 or to data equipment operated by a service provider (not shown). The signals through the various networks and the signals on network link 210 and through communication interface 208, which carry the digital data to and from MCD 100, are exemplary forms of carrier waves transporting the information.

MCD 100 can send messages and receive data, including program code, through the network(s), network link 210 and communication interface 208. Received code may be executed by processor 204 as it is received, and/or stored in memory 206 for later execution. In this manner, MCD 100 may obtain application code in the form of a carrier wave.

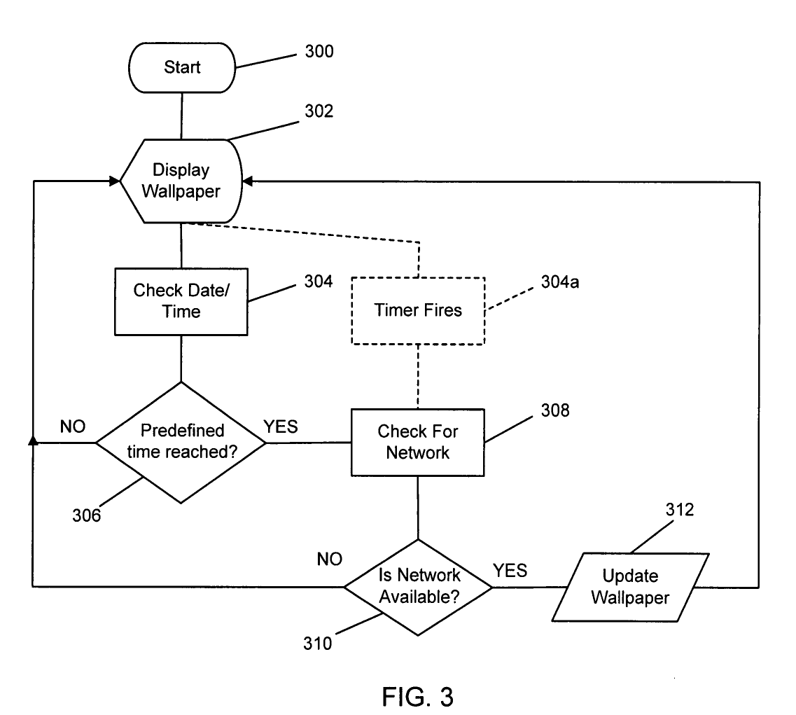

Operation of the first embodiment, briefly described above, is now described in detail with reference to FIG. 3 depicting a high level process flow according to said embodiment. The process begins at start step 300 and proceeds to step 302 wherein wallpaper is displayed on display 106 of MCD 100, e.g., calendar 110. The user is able to view the displayed calendar 110 as the background image displayed on MCD 100. In one embodiment, for example, calendar 110 includes a display of the current month and days of the month in grid fashion. A day of the month having an appointment is indicated by a marker on the particular day, e.g., the “*” (asterisk) on calendar 110.

After a preset period of time elapses, processor 204 proceeds to step 304 and determines the current time. The preset period of time may be a static or dynamic value. The flow proceeds to step 306 and processor 204 compares the current time to a predefined update time. The user sets the predefined update time by manipulation of input device 120. In an alternate embodiment, the predefined update time may be specified as a default setting based on the MCD 100, communication network 104, or computer system 102. The predefined update time may be stored on MCD 100 or on a networked device connected to communication network 104.

At step 306, if the predefined update time has been reached, the flow proceeds to step 308. If the predefined update time has not been reached, the flow proceeds to return to step 302 and the current wallpaper is displayed on display 106, e.g., calendar 110 remains displayed in current form.

In a further alternate embodiment, a timer is used to determine the process flow from step 302 to step 308 as follows. The user specifies a frequency for MCD 100 to perform update checks using user input device 120, and processor 204 sets a timer. Upon the expiration or “firing” of the timer at step 304a (dashed line), processor 204 resets the timer for another period and the process flow proceeds to step 308.

In step 308, processor 204, via communication interface 208, determines if MCD 100 is able to connect to communication network 104 and the flow proceeds to step 310. In step 310, if communication network 104 is not available, the flow proceeds to return to step 302 and the current wallpaper is displayed on display 106 as described above. If communication network 104 is available, the flow proceeds to step 312 and processor 204 uses communication interface 208 to obtain updated wallpaper for display, e.g., by accessing computer system 102 via communication network 104. Processor 204 replaces the current wallpaper with the obtained updated wallpaper. After obtaining updated wallpaper, the processor flow proceeds to step 302 and causes display 106 to display the obtained updated wallpaper, now the current wallpaper, on MCD 100 to the user.

In an alternate embodiment, processor 204 performs a check of the wallpaper accessed on computer system 102 in order to determine if the computer system wallpaper is more recent than the current wallpaper on MCD 100 during step 312. One or more of a variety of mechanisms may be used to check whether the computer system wallpaper is more recent than the current wallpaper, e.g., file creation/modification date comparisons, etc.

In a further alternate embodiment, MCD 100 assumes a connection with communication network 104 and the determination of whether a network connection exists and appropriating branching of the process flow based on the determination outcome (steps 308 and 310) are not performed.

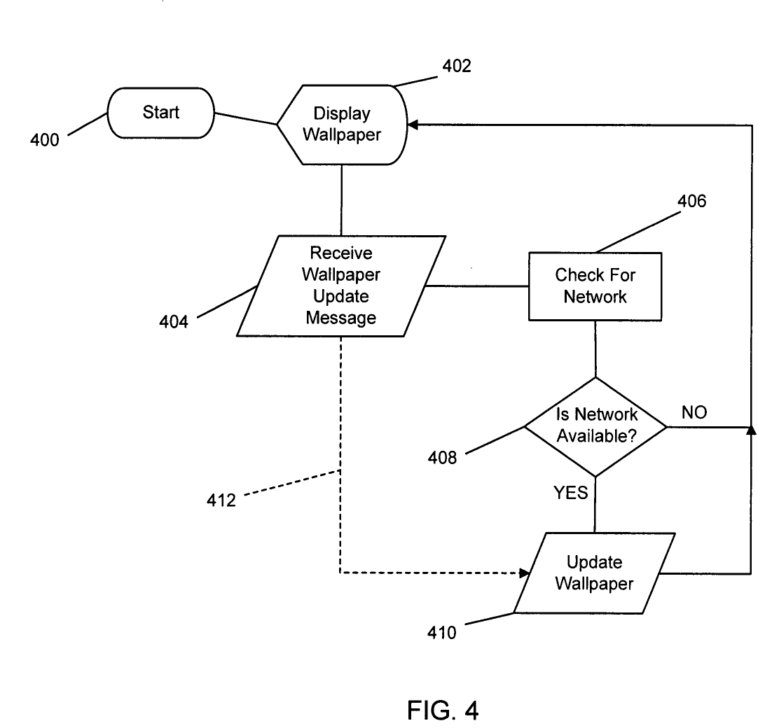

Operation of the second embodiment, described briefly above, is now described in detail with reference to FIG. 4 depicting a high level process flow according to said embodiment. The process begins at start step 400 and proceeds to step 402 wherein wallpaper is displayed on display 106 of MCD 100, e.g., calendar 110 similar to the process flow of FIG. 3. The user is able to view the displayed calendar 110 as the background image displayed on MCD 100.

The flow proceeds to step 404 wherein MCD 100 receives, via communication network 104 and communication interface 208, a wallpaper update message, e.g., from computer system 102. Wallpaper update message may be transmitted via any message transfer mechanism over communication network 104, e.g., in one embodiment, wallpaper update message is a short message service (SMS) message.

The wallpaper update message includes a wallpaper location reference for indicating from where MCD 100 is to obtain the updated wallpaper, e.g., a uniform resource locator (URL), an Internet protocol (IP) address, or other location identifying mechanism. Additionally, if the MCD 100 includes a preset location from which to obtain the updated wallpaper, the wallpaper location reference may include only a particular name for a file to be retrieved from the preset location. In an alternate embodiment, the wallpaper update message includes the wallpaper itself in the message payload.

After receipt of wallpaper update message, the flow proceeds to step 406 wherein processor 204, via communication interface 208, determines if MCD 100 is able to connect to communication network 104 and the flow proceeds to step 408. In step 408, if communication network 104 is not available, the flow proceeds to return to step 402 and the current wallpaper is displayed on display 106 as described with respect to FIG. 3. If communication network 104 is available, the flow proceeds to step 410 and processor 204 uses communication interface 208 to obtain updated wallpaper for display, e.g., by accessing computer system 102 via communication network 104. Processor 204 replaces the current wallpaper with the obtained updated wallpaper. After obtaining updated wallpaper, the processor flow proceeds to step 402 and causes display 106 to display the obtained updated wallpaper, now the current wallpaper, on MCD 100 to the user.

In an alternate embodiment, processor 204 relies on the receipt of wallpaper update message as a determination that a connection to communication network 104 is available and proceeds directly (dashed line 412) to step 410 to obtain the updated wallpaper as described above.

Similar to step 312 described above with respect to FIG. 3, in an alternate embodiment, processor 204 performs a check of the wallpaper accessed on computer system 102 in order to determine if the computer system wallpaper is more recent than the current wallpaper on MCD 100 during step 410.

In a further alternate embodiment in accordance with dashed line 412, the wallpaper update message received in step 404 includes the updated wallpaper to be displayed on display 106. The flow proceeds to step 410 and processor 204 replaces the current wallpaper with the received updated wallpaper and the flow proceeds to step 402 wherein the updated wallpaper is displayed.

In one embodiment, wallpaper update message is transmitted to MCD 100 over the same protocol as the updated wallpaper is obtained. In another embodiment, wallpaper update message is transmitted to MCD 100 over a different protocol, thereby providing an ability to differentiate transmission of information based on size. That is, the wallpaper update message is typically much smaller in size than the updated wallpaper and requires less bandwidth to transmit.

In a further embodiment, MCD 100 queries the user whether to update the currently displayed wallpaper on display 106 prior to replacing the currently displayed wallpaper. The user query may occur prior to obtaining the updated wallpaper, during the update wallpaper step, and prior to displaying the updated wallpaper. Similarly, MCD 100 may notify the user of updated wallpaper via information and/or an indicator displayed on display 106. For example, a timestamp may be applied to the update wallpaper to indicate the update time. In alternate embodiments, the user may decide to not receive a query and/or notification.

User preferences relating to the wallpaper content, timing of updates, and notification may be stored in memory 206 of MCD 100 or on a networked device connected to communication network 104, as appropriate for each of the described embodiments.

In a further embodiment, processor 204 retains the original wallpaper displayed in memory 206 and updates a reference in the memory 206 causing the updated wallpaper to be displayed on display 106 in update wallpaper steps 312, 410. That is, processor 204 does not overwrite the current wallpaper with the updated wallpaper.

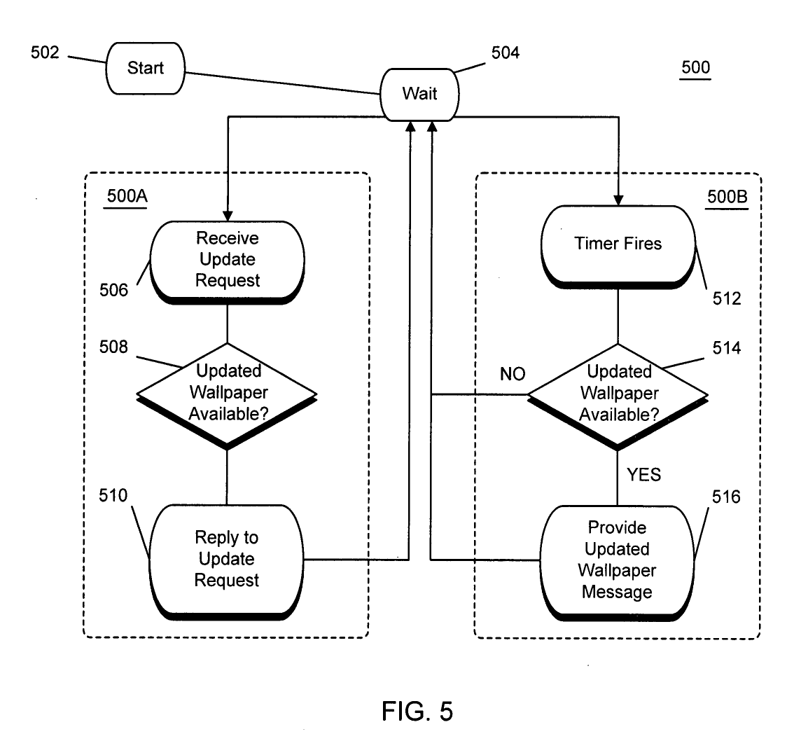

FIG. 5 depicts a process flow diagram of operation of an embodiment of an update component 500 executed by computer system 102 in accordance with the above-described functionality of MCD 100. As depicted in FIG. 5, update component 500 includes two sub-components: a message handler 500A and a timer handler 500B. Message handler 500A includes functionality for receiving and responding to messages received from communication network 104. Timer handler 500B includes functionality for handling timer-based functionality.

The process flow begins at start step 502 and proceeds to wait state 504 where upon occurrence of one of two events the process proceeds to either message handler 500A or timer handler 500B.

If an update wallpaper request message is received by computer system 102 from MCD 100 via communication network 104, the flow proceeds to message handler 500A and step 506. Then, the flow proceeds to step 508 and computer system 102 determines whether updated wallpaper is available using one or more previously described methods.

The flow then proceeds to step 510 and computer system 102 transmits a reply to the update wallpaper request message based on the outcome of the step 508 determination. If the step 508 determination is negative, the reply to the update wallpaper request message transmitted by computer system 102 indicates that updated wallpaper is unavailable and the flow proceeds to return to step 504. However, if the step 508 determination is positive, the reply to the update wallpaper request message transmitted by computer system 102 indicates that updated wallpaper is available (step 510) and the flow proceeds to return to step 504. In one embodiment, computer system 102 includes the updated wallpaper in the positive update wallpaper request message transmitted during step 510 similar to step 516 described below. In another embodiment, an additional request for the updated wallpaper is required to be received from MCD 100 prior to transmitting the updated wallpaper.

If a previously set timer expires or “fires” at computer system 102, the flow proceeds to timer handler 500B and step 512. In one embodiment, the user of MCD 100 is able to specify the timer setting at MCD 100 which is then provided to computer system 102 via communication network 104. Alternatively, computer system 102 sets a timer value based on a default value, the content specified by the user at MCD 100, time of day, and other parameters related to the content, origination location of the content, user-specified parameters, etc. The timer setting may specify a time period and/or a time at which the timer expires. Then, the flow proceeds to step 514 and computer system 102 determines whether updated wallpaper is available, as described above.

The flow then proceeds to step 516 and if the step 514 determination is negative, the flow proceeds to return to step 504. However, if the step 514 determination is positive, computer system 102 transmits an updated wallpaper message including the updated wallpaper to MCD 100 via communication network 104. In another embodiment, updated wallpaper message includes only an indication that updated wallpaper is available and an additional request for the updated wallpaper is required to be received from MCD 100 prior to transmission of the updated wallpaper to MCD 100.

The process flow then proceeds to return to step 504.

In one or more alternate embodiments, one or the other or both of message handler 500A and timer handler 500B are included in update component 500 of computer system 102.

It will be readily seen by one of ordinary skill in the art that embodiments fulfill many of the advantages set forth above. After reading the foregoing specification, one of ordinary skill will be able to affect various changes, substitutions of equivalents and various other aspects of embodiments as broadly disclosed herein. It is therefore intended that the protection granted hereon be limited only by the definition contained in the appended claims and equivalents thereof.

What is claimed is:

1. A method of dynamically updating a mobile communication device display, comprising:
displaying wallpaper on the display, wherein the wallpaper includes dynamic content; and
automatically updating the wallpaper on the display.

2. The method as claimed in claim 1, wherein the dynamic content includes at least one of calendar information, weather information, traffic information, navigation information, entertainment information, sports information, financial information, and news information.

3. The method as claimed in claim 1, wherein the updating step is performed in response to at least one of:
(1) elapsing of a threshold time period and availability of updated content and (2) receipt of an update request message.

4. The method as claimed in claim 1, wherein the updating step is performed in response to receipt of an update request message and the update request message includes at least one of the content to be displayed, and a reference to the content.

5. The method as claimed in claim 1, wherein the reference to the content is at least one of predefined and user configurable.

6. The method as claimed in claim 1, wherein the updating step is performed in accordance with at least one of:
periodically, at a predefined time, and in response to a user input.

7. The method as claimed in claim 1, further comprising the step of:
redisplaying the wallpaper on the display, if a threshold time period has elapsed and updated content is unavailable.

8. A computer-readable medium for automatically updating a wallpaper display on a mobile communication device, comprising:
at least one sequence of instructions, wherein execution of the instructions by a processor causes the processor to perform the steps as claimed in claim 1.

9. A computer system for dynamically updating a mobile communication device display, comprising:
a network interface adapted to communicate with a mobile communication device; and
an update component for automatically determining whether wallpaper including dynamic content is to be transferred to the mobile communication device via the network interface.

10. The system as claimed in claim 9, wherein the dynamic content includes at least one of calendar information, weather information, traffic information, sports information, financial information, and news information.

11. The system as claimed in claim 9, wherein the update component transfers wallpaper to the mobile communication device if a threshold time period has elapsed and updated wallpaper is available.

12. The system as claimed in claim 9, wherein the update component transfers wallpaper to the mobile communication device if a timer fires and updated wallpaper is available.

13. The system as claimed in claim 9, wherein the update component transfers wallpaper to the mobile communication device in response to receipt of an update request message.

14. A mobile communication device for automatically updating wallpaper, comprising:
a processor;
a display coupled to the processor and displaying wallpaper responsive to the processor;
a memory coupled to the processor having instructions which, when executed by the processor, cause the processor to display wallpaper on the display, and automatically update the wallpaper on the display, wherein the wallpaper includes dynamic content.

15. The device as claimed in claim 14, wherein the instructions causing the processor to automatically update the wallpaper on the display execute if a time period has elapsed and updated content is available.

16. The device as claimed in claim 14, wherein the instructions causing the processor to automatically update the wallpaper on the display execute at a given time and if updated content is available.

17. The device as claimed in claim 14, wherein the instructions causing the processor to automatically update the wallpaper on the display execute in response to receipt of an updated wallpaper message.

18. A system for automatically updating a wallpaper displayed on a mobile communication device display, comprising:
communication means for automatically receiving updated wallpaper for display on the mobile communication device; and
updating means for automatically updating wallpaper including dynamic content, if updated wallpaper is available for transfer to the mobile communication device.

19. The system as claimed in claim 18, wherein the updating means receives a wallpaper update message including updated wallpaper for display.

20. The system as claimed in claim 18, wherein the updating means automatically updates the displayed wallpaper at a specified time, after a threshold time period has elapsed, and responsive to receipt of an updated wallpaper message.
